(19) United States
(12) Patent Application Publication
(10) Pub. No.: US 2022/0363944 A1
(43) Pub. Date: Nov. 17, 2022

(54) INKJET INK, 3D PRINTING METHOD, AND 3D PRINTING OBJECT

(71) Applicant: INDUSTRIAL TECHNOLOGY RESEARCH INSTITUTE, Hsinchu (TW)

(72) Inventors: Yi-Tsung PAN, Tainan City (TW); Shinn-Jen CHANG, Hsinchu City (TW); Wesley Jen-Yang CHANG, Tainan City (TW); Feng-Meei WU, Hsinchu City (TW); Po-Hsien HO, Taipei City (TW); Chung-Han YU, Changhua City (TW)

(73) Assignee: INDUSTRIAL TECHNOLOGY RESEARCH INSTITUTE, Hsinchu (TW)

(21) Appl. No.: 17/733,102

(22) Filed: Apr. 29, 2022

Related U.S. Application Data
(60) Provisional application No. 63/181,506, filed on Apr. 29, 2021.

(30) Foreign Application Priority Data
Dec. 13, 2021 (TW) 110146539

(51) Int. Cl. C09D 181/04; C09D 151/08; B33Y 10/00; B33Y 70/00; B33Y 40/20; B29C 64/165

(52) U.S. Cl. CPC C09D 181/04; C09D 151/08; B33Y 10/00; B33Y 70/00; B33Y 40/20; B29C 64/165; B29K 2081/06

(57) ABSTRACT

An inkjet ink is provided. The inkjet ink includes a modified high-performance engineering plastic, a polar solvent, and a wetting agent. Additionally, a 3D printing method and a 3D printing object are provided. The modified high-performance engineering plastic includes modified polyphenylene sulfide, modified polyether-ether-ketone, modified polyether sulfone, modified polyphenylsulfone, or modified polysulfone.

### CROSS REFERENCE TO RELATED APPLICATIONS

This application claims the benefit of U.S. Provisional Application No. 63/181,506 filed on Apr. 29, 2021, the entirety of which is incorporated by reference herein.

The present application is based on, and claims priority from, Taiwan Application Serial Number 110146539, filed on Dec. 13, 2021, the disclosure of which is hereby incorporated by reference herein in its entirety.

### TECHNICAL FIELD

The technical field relates to a 3D printing method, and in particular it relates to an ink composition for the 3D printing method.

### BACKGROUND

The high-performance engineering plastic such as polyphenylene sulfide (PPS), polyether-ether-ketone (PEEK), polyether sulfone (PES), polyphenylsulfone (PPSU), or polysulfone (PS) has good chemical resistance and cannot be dissolved in solvent, thereby cannot be formulated as an inkjet ink for inkjet printing technology to manufacture 3D printing products. Currently, only laser scanning molding 3D printing technology can print polyphenylene sulfide material, but it has shortcomings such as slow printing speed and high manufacturing cost, and the powder used for printing cannot be recycled. As such, it is difficult to use high-performance engineering plastic in 3D printing.

Accordingly, a technology of dispersing the high-performance engineering plastic in the ink is called for to address the above issues.

### SUMMARY

One embodiment of the disclosure provides an inkjet ink, including a modified high-performance engineering plastic, a polar solvent, and a wetting agent.

One embodiment of the disclosure provides a 3D printing method, including (1) forming a first powder layer of a high-performance engineering plastic; (2) applying an inkjet ink to the first powder layer to form a first pattern in the first powder layer, wherein the ink includes a modified high-performance engineering plastic, a polar solvent, and a wetting agent; (3) pre-heating the first powder layer; (4) forming a second powder layer of the high-performance engineering plastic on the pre-heated first powder layer; (5) applying the inkjet ink to the second powder layer to form a second pattern in the second powder layer; (6) pre-heating the second powder layer; (7) removing parts of the first powder layer and the second powder layer that are not in contact with the inkjet ink; and (8) baking the remaining parts of the first powder layer and the second powder layer to form a 3D printing object.

One embodiment of the disclosure provides a 3D printing object, including a high-performance engineering plastic and a modified high-performance engineering plastic being homogeneously mixed, wherein the high-performance engineering plastic includes polyphenylene sulfide, polyether-ether-ketone, polyether sulfone, polyphenylsulfone, or polysulfone, and the modified high-performance engineering plastic includes modified polyphenylene sulfide, modified polyether-ether-ketone, modified polyether sulfone, modified polyphenylsulfone, or modified polysulfone.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIGS. 1 to 8 show a 3D printing method in one embodiment of the disclosure.

### DETAILED DESCRIPTION

In the following detailed description, for the purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

One embodiment of the disclosure provides an inkjet ink, including a modified high-performance engineering plastic, a polar solvent, and a wetting agent. The inkjet ink can be utilized in the 3D printing technology. The modified high-performance engineering plastic may include modified polyphenylene sulfide, modified polyether-ether-ketone, modified polyether sulfone, modified polyphenylsulfone, or modified polysulfone.

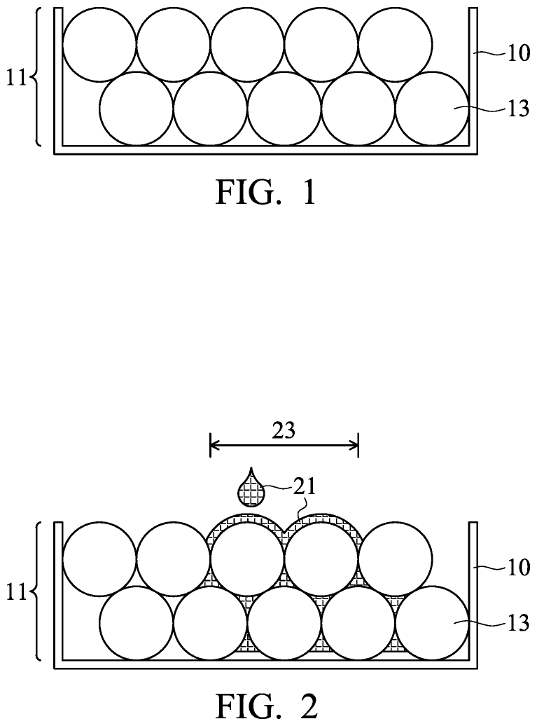

One embodiment of the disclosure provides a 3D printing method. As shown in FIG. 1, forming a powder layer 11 of a high-performance engineering plastic in a powder bed 10 (e.g. a tank). For example, the powder layer 11 formed from powder 13 of high-performance engineering plastic has a thickness of 0.005 mm to 1 mm. If the thickness of the powder layer 11 is too little, the scratch defect will be easily formed in the powder layer. If the thickness of the powder layer 11 is too large, the printing surface will be rough and the printing resolution will be low. In some embodiments the powder 13 of high-performance engineering plastic has a diameter of 1 μm to 200 μm. If the diameter of the powder 13 is too little, the powder will be easily influenced by electrostatic force and difficult to be spread as a layer. If the diameter of the powder 13 is too large, the printing surface will be rough and the printing resolution will be low. In some embodiments, the high-performance engineering plastic includes polyphenylene sulfide, polyether-ether-ketone, polyether sulfone, polyphenylsulfone, polysulfone, or another suitable high-performance engineering plastic. The polyphenylene sulfide has a repeating unit of

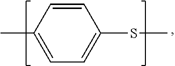

the polyether-ether-ketone has a repeating unit of

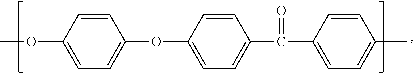

the polyether sulfone has a repeating unit of

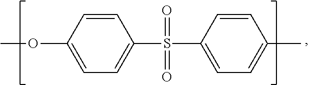

the polyphenylsulfone has a repeating unit of

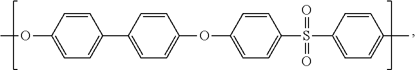

and the polysulfone has a repeating unit of

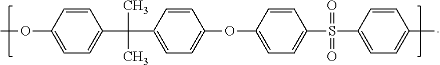

In some embodiments, the high-performance engineering plastic has a weight average molecular weight of 10000 to 150000. If the weight average molecular weight of the high-performance engineering plastic is too low, the printed product will have a low mechanical strength. If the weight average molecular weight of the high-performance engineering plastic is too high, it will be difficult to synthesize the high-performance engineering plastic printed product.

As shown in FIG. 2, an inkjet ink 21 is applied to a powder layer 11 to form a first pattern 23 in the powder layer 11. The inkjet ink 21 includes a modified high-performance engineering plastic 31, a polar solvent, and a wetting agent. The modified high-performance engineering plastic 31 may include modified polyphenylene sulfide, modified polyether-ether-ketone, modified polyether sulfone, modified polyphenylsulfone, or modified polysulfone. Specifically, the modified high-performance engineering plastic 31 may include (A) poly(alkyl-4-(thiophenyl)sulfinylbenzene); (B) polyphenylene sulfide, polyether-ether-ketone, polyether sulfone, or polyphenylsulfone grafted with carboxylate, sulfonate, phosphate, or nitrate; (C) polyphenylene sulfide, polyether-ether-ketone, polyether sulfone, or polyphenylsulfone grafted with primary amine or nitro; or (D) polysulfone inserted with polyether chain, long carbon chain, or a combination thereof

For example, (A) poly(alkyl-4-(thiophenyl)sulfinylbenzene) may have a repeating unit of

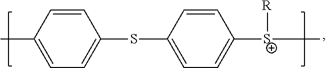

wherein R can be alkyl group, and the method of forming the same may refer to the Taiwan Patent No. I652254B that was previously applied by the applicant.

For example, (B) polyphenylene sulfide grafted with carboxylate, sulfonate, phosphate, or nitrate may have a repeating unit of

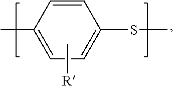

wherein R′ can be COO⁻, SO₃⁻, PO₄²⁻, or NO₃. (B) polyether-ether-ketone grafted with carboxylate, sulfonate, phosphate, or nitrate may have a repeating unit of

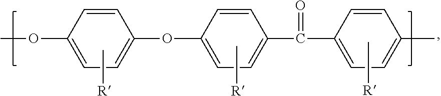

wherein each of R′ can be independently H, COO⁻, SO₃⁻, PO₄²⁻, or NO₃⁻, and at least one of R′ is not H. (B) polyether sulfone grafted with carboxylate, sulfonate, phosphate, or nitrate may have a repeating unit of

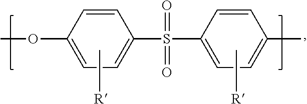

wherein each of R′ can be independently H, COO⁻, SO₃⁻, PO₄²⁻, or NO₃⁻, and at least one of R′ is not H. (B) polyphenylsulfone grafted with carboxylate, sulfonate, phosphate, or nitrate may have a repeating unit of

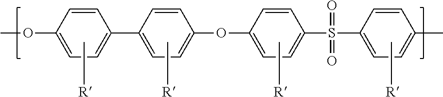

wherein each of R′ can be independently H, COO⁻, SO₃⁻, PO₄²⁻, or NO₃⁻, and at least one of R′ is not H. The method of forming (B) polyphenylene sulfide, polyether-ether-ketone, polyether sulfone, or polyphenylsulfone grafted with carboxylate, sulfonate, phosphate, or nitrate may refer to EP0672722A2, U.S. Pat. Nos. 7,601,449B2, 6,984,713B2, EP2398578A1, EP2816069B1, U.S. Pat. No. 10,683,415B2, or Journal of Applied polymer Science, volume 127, issue 5.

For example, (C) polyphenylene sulfide grafted with primary amine or nitro may have a repeating unit of

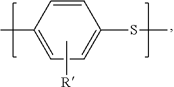

wherein R′ can be NH₂ or NO₂. (C) polyether-ether-ketone grafted with primary amine or nitro may have a repeating unit of

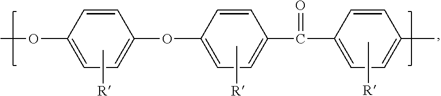

wherein each of R′ is independently H, NH₂, or NO₂, and at least one of R′ is not H. (C) polyether sulfone grafted with primary amine or nitro may have a repeating unit of

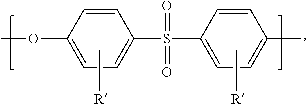

wherein each of R′ is independently H, NH₂, or NO₂, and at least one of R′ is not H. (C) polyphenylsulfone grafted with primary amine or nitro may have a repeating unit of

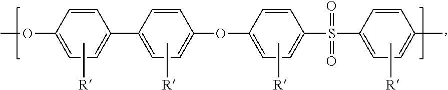

wherein each of R′ is independently H, NH₂, or NO₂, and at least one of R′ is not H. The method of forming (C) polyphenylene sulfide, polyether-ether-ketone, polyether sulfone, or polyphenylsulfone grafted with primary amine or nitro may refer to U.S. Pat. No. 10,683,415B2, WO2002077068A2, and Macromolecules 1995, 28, 23, 7612-7621.

For example, (D) polysulfone inserted with polyether chain, long carbon chain, or a combination thereof may have a repeating unit of

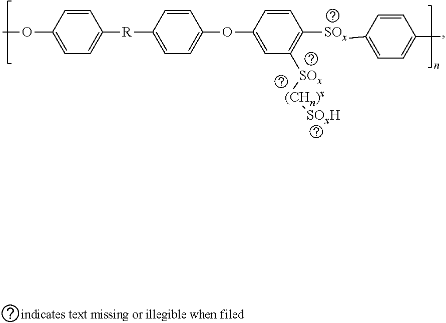

wherein R is polyether chain, long carbon chain, or a combination thereof. The method of forming (D) polysulfone inserted with polyether chain, long carbon chain, or a combination thereof may refer Journal of Membrane Science 2010, 351, 87-95 and Journal of Membrane Science 2004, 230, 61-70.

It should be noted that the high-performance engineering plastic in the powder layer 11 and the modified high-performance engineering plastic 31 have a similar chemical structure. For example, if the high-performance engineering plastic is polyphenylene sulfide, the modified high-performance engineering plastic 31 will be the modified polyphenylene sulfide such as (A) poly(alkyl-4-(thiophenyl)sulfinylbenzene); (B) polyphenylene sulfide grafted with carboxylate, sulfonate, phosphate, or nitrate; or (C) polyphenylene sulfide grafted with primary amine or nitro, rather than the modified polyether-ether-ketone, the modified polyether sulfone, the modified polyphenylsulfone, or the modified polysulfone. Similarly, if the high-performance engineering plastic is polyether-ether-ketone, the modified high-performance engineering plastic 31 will be the modified polyether-ether-ketone such as (B) polyether-ether-ketone grafted with carboxylate, sulfonate, phosphate, or nitrate; or (C) polyether-ether-ketone grafted with primary amine or nitro, rather than the modified polyphenylene sulfide, the modified polyether sulfone, the modified polyphenylsulfone, or the modified polysulfone. If the high-performance engineering plastic is polyether sulfone, the modified high-performance engineering plastic 31 will be the modified polyether sulfone such as (B) polyether sulfone grafted with carboxylate, sulfonate, phosphate, or nitrate; or (C) polyether sulfone grafted with primary amine or nitro, rather than the modified polyphenylene sulfide, the modified polyether-ether-ketone, the modified polyphenylsulfone, or the modified polysulfone. If the high-performance engineering plastic is polyphenylsulfone, the modified high-performance engineering plastic 31 will be the modified polyphenylsulfone such as (B) polyphenylsulfone grafted with carboxylate, sulfonate, phosphate, or nitrate; or (C) polyphenylsulfone grafted with primary amine or nitro, rather than the modified polyphenylene sulfide, the modified polyether-ether-ketone, the modified polyether sulfone, or the modified polysulfone. If the high-performance engineering plastic is polysulfone, the modified high-performance engineering plastic 31 will be the modified polysulfone such as (D) polysulfone inserted with polyether chain, long carbon chain, or a combination thereof rather than the modified polyphenylene sulfide, the modified polyether-ether-ketone, the modified polyether sulfone, or the modified polyphenylsulfone.

In some embodiments, the modified high-performance engineering plastic 31 has a weight average molecular weight of 6000 to 150000. If the weight average molecular weight of the modified high-performance engineering plastic 31 is too low, the printed product will have a poor mechanical strength. If the weight average molecular weight of the modified high-performance engineering plastic 31 is too high, the modified high-performance engineering plastic 31 will be difficult to dissolve or dispersed in the solvent.

In some embodiments, the polar solvent in the inkjet ink 21 has a Hansen solubility parameter δ of 21.5 to 33. For example, the polar solvent can be dimethyl sulfoxide (DMSO), dimethyl acetamide (DMAc), ethylene glycol (EG), or a combination thereof. The polar solvent may include some N-methylpyrrolidone (NMP), but the major solvent should not be NMP to avoid the insufficient stability of the inkjet ink. In addition, suitable amount of other polar solvent, such as ethanol, propanol, butanol, or a combination thereof, may be added into the ink for accelerating drying rate. In some embodiments, the modified high-performance engineering plastic 31 and the polar solvent have a weight ratio of 1:99 to 1:1. If the polar solvent amount is too low, the inkjet ink 21 may have an overly high viscosity. If the polar solvent amount is too high, the inkjet ink may have an overly low viscosity or an overly low surface tension. For example, the inkjet ink 21 has a surface tension of 20 dyne/cm to 40 dyne/cm and a viscosity of 8 cp to 30 cp at 20° C. to 60° C. If the inkjet ink 21 has an overly low viscosity or an overly low surface tension, the printed ink will be easily smeared to cause pattern distortion. If the inkjet ink 21 has an overly high viscosity or an overly high surface tension, the inkjet ink may block the printing head and cannot be smoothly inkjet printed.

The inkjet ink 21 contains the wetting agent to achieve the desired properties of the inkjet ink 21. The wetting agent can be siloxane-type surfactant, such as BYK-345, 346, 347, 348, 349, 3455, or a combination thereof commercially available from BYK. In some embodiments, the modified high-performance engineering plastic and the wetting agent have a weight ratio of 1:0.002 to 1:0.4. If the amount of the wetting agent is too low, the surface tension of the inkjet will be too high. If the amount of the wetting agent is too high, the surface tension of the inkjet ink will be too low.

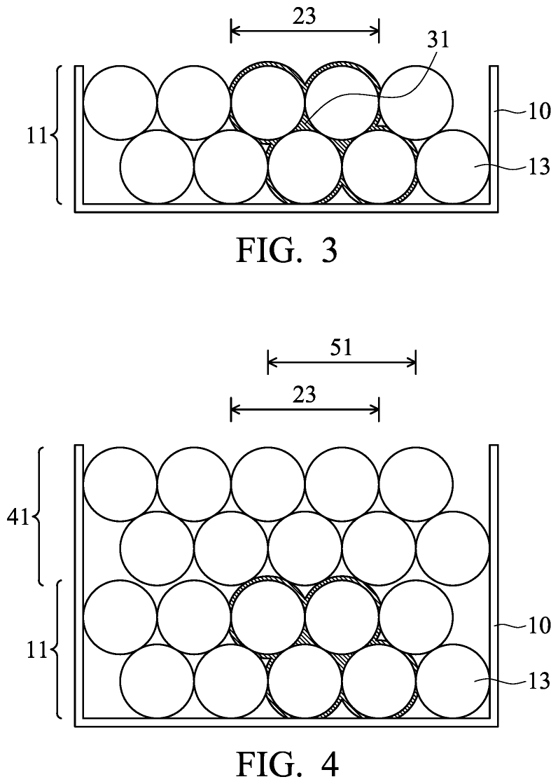

As shown in FIG. 2, the inkjet ink 21 is in contact with the powder 13 in the first pattern 23, and not in contact with the powder 13 outside the first pattern 23. As shown in FIG. 3, then, the powder layer 11 is pre-heated. The solvent in the inkjet ink 21 can be removed during pre-heating, and the modified high-performance engineering plastic 31 in the inkjet ink 21 may interact with the surface of the powder 13. It should be noted that if the modified high-performance engineering plastic 31 is (A) poly(alkyl-4-(thiophenyl)sulfinylbenzene), which can transform into polyphenylene sulfide by the pre-heating step. In some embodiments, the step of pre-heating the powder layer 11 is performed at a temperature of 120° C. to 180° C. If the temperature of pre-heating the powder layer 11 is too low, the solvent may remain, affecting the subsequent process. If the temperature of pre-heating the powder layer 11 is too high, the powder that is not in contact with the inkjet ink 13 will be partially fused and cannot be recycled.

As shown in FIG. 4, a powder layer 41 of high-performance engineering plastic is then formed on the pre-heated powder layer 11. The powder layer 41 is similar to the powder layer 11, and its detailed description is not repeated here for simplification. However, the thickness of the powder layer 41 and the thickness of the powder layer 11 can be same or different, and the powder diameter in the powder layer 41 and the powder diameter in the powder layer 11 can be same or different as desired.

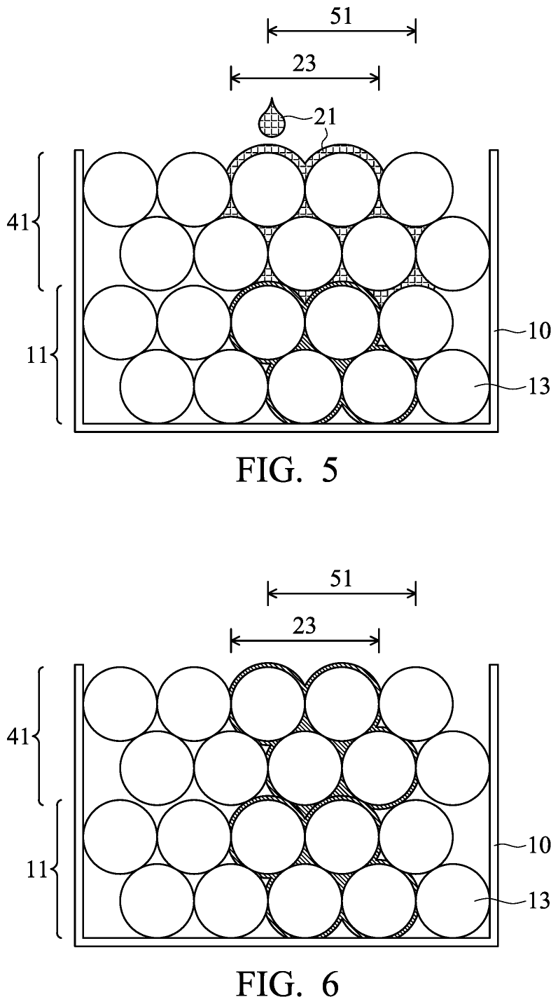

As shown in FIG. 5, the inkjet ink 21 is then applied to the powder layer 41 to form a second pattern 51 in the powder layer 41. The inkjet ink 21 is in contact with the powder 13 in the second pattern 51, and not in contact with the powder 13 outside the second pattern 51. In FIG. 5, some inkjet ink 21 flows into the space between the powder layer 11 and the powder layer 41. However, the inkjet ink 21 will not flow to the space outside the first pattern 23 (between the powder layer 11 and the powder layer 41) when the second pattern 51 is larger than the first pattern 23, thereby preventing the final 3D printing object from deformation.

As shown in FIG. 5, the powder layer 41 is pre-heated. This step is similar to the described step of pre-heating the powder layer 11, and its detailed description is not repeated here for simplification.

The steps of FIGS. 4 to 6 can be repeated several times if necessary. In other words, the steps of forming the powder layer of the powder 13, applying the inkjet ink 21 to the powder layer to form a pattern, and pre-heating the powder layer can be repeated as desired.

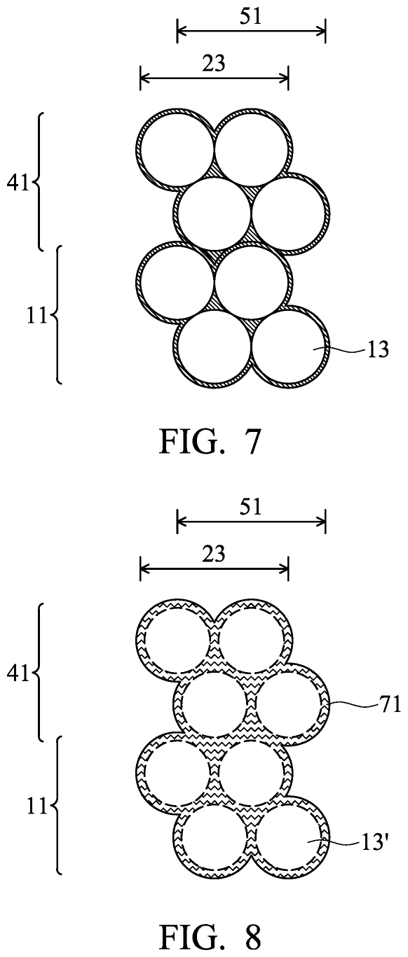

As shown in FIG. 7, parts of the powder layers 11 and 41 that are not in contact with the inkjet ink 21 (e.g. the parts outside the first pattern 23 and second pattern 51) are removed. The removed powder 13 can be recycled to manufacture another 3D printing product.

As shown in FIG. 8, the remaining parts (e.g. the pattern parts) of the powder layers 11 and 41 are baked to form a 3D printing object. The modified high-performance engineering plastic 31 and the surface of the powder 13 are fused to form a homogeneous mixture 71, and the shrunk powder 13′ (the surface part of the powder 13 is fused and mixed with the modified high-performance engineering plastic 31, such that the diameter of the powder 13 was shrunk) is distributed in the homogeneous mixture 71. It should be noted that if the modified high-performance engineering plastic 31 is (A) poly(alkyl-4-(thiophenyl)sulfinylbenzene), the modified high-performance engineering plastic 31 will transfer to polyphenylene sulfide during pre-heating, as described above. As such, the homogeneous mixture 71 and the shrunk powder 13′ in FIG. 8 are the same material (e.g. polyphenylene sulfide). Alternatively, the 3D printing object includes the high-performance engineering plastic and the modified high-performance engineering plastic being homogeneously mixed. The high-performance engineering plastic includes polyphenylene sulfide, polyether-ether-ketone, polyether sulfone, polyphenylsulfone, or polysulfone, and the modified high-performance engineering plastic includes modified polyphenylene sulfide, modified polyether-ether-ketone, modified polyether sulfone, modified polyphenylsulfone, or modified polysulfone. For example, the modified high-performance engineering plastic can be (B) polyphenylene sulfide, polyether-ether-ketone, polyether sulfone, or polyphenylsulfone grafted with carboxylate, sulfonate, phosphate, or nitrate; (C) polyphenylene sulfide, polyether-ether-ketone, polyether sulfone, or polyphenylsulfone grafted with primary amine or nitro; or (D) polysulfone inserted with polyether chain, long carbon chain, or a combination thereof In some embodiments, the step of baking the remaining parts of the powder layer 11 and the powder layer 41 to form the 3D printing object is performed at a temperature of 250° C. to 350° C. If the baking temperature is too low, the fusion will be incomplete, lowering the strength of the 3D printing object. If the baking temperature is too high, the 3D printing object will deform.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

In the following Examples, the wetting agent B46 was BYK-346 commercially available from BYK, the wetting agent B44 was BYK-345 commercially available from BYK, the wetting agent B42 was BYK-348 commercially available from BYK, the wetting agent K64 was BYK-349 commercially available from BYK, and the wetting agent K48 was BYK-3455 commercially available from BYK.

In the following Examples, poly(methyl-4-(thiophenyl)sulfinylbenzene) (hereinafter referred as ionized PPS1) could be prepared by the method disclosed in Example 7 of Taiwan Patent No. I652254B. The ionized PPS1 had a weight average molecular weight of 9000 and a repeating unit of

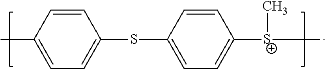

Another poly(methyl-4-(thiophenyl) sulfinylbenzene) (hereinafter referred as ionized PPS2) could be prepared by the method disclosed in Example 7 of Taiwan Patent No. I652254B with a longer reaction period. The ionized PPS2 had a weight average molecular weight of 120000 and a repeating unit of

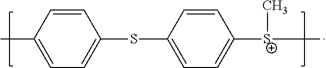

The polyether-ether-ketone grafted with sulfonate (hereinafter referred as SPEEK) could be prepared by the method disclosed in Example 3 of WO2002077068A2. SPEEK had a weight average molecular weight of 12000 and a repeating unit of

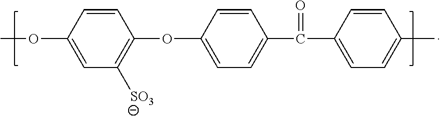

The polyether sulfone grafted with primary amine (hereinafter referred as amino PES) could be prepared by the method disclosed in Macromolecules 1995, 28, 23, 7612-7621. The amino PES had a weight average molecular weight of 8000 and a repeating unit of

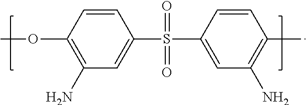

In the following Examples, the viscosity of the ink was measured according to the standard ASTM D4402, the surface tension of the ink was measured according to the standard ASTM D1331-14, and the tensile strength of the 3D printing object was measured according to the standard ASTM D638.

### Example 1

1 part by weight of B46, 1 part by weight of K64, 1 part by weight of K48, 73 parts by weight of NMP, 7 parts by weight of ethanol, 5 part by weight of propanol, and 12 parts by weight of the ionized PPS1 were mixed to form an ink. The ink had a surface tension of 23.5 dyne/cm and a viscosity of 8.1 cp at 30° C. The ink was inkjet printed onto a powder layer of PPS, and then heated to 280° C. to form a 3D printing object having a tensile strength of 528±53 kg/cm². After being stood overnight, suspension occurred in the ink, which means that the stability of the ink was poor.

### Example 2

1 part by weight of B46, 1 part by weight of K64, 1 part by weight of K48, 65.5 parts by weight of NMP, 7.5 parts by DMSO, 8 parts by weight of ethanol, 4 part by weight of propanol, and 15 parts by weight of the ionized PPS1 were mixed to form an ink. The ink had a surface tension of 24.1 dyne/cm and a viscosity of 8.8 cp at 30° C. The ink was inkjet printed onto a powder layer of PPS, and then heated to 280° C. to form a 3D printing object having a tensile strength of 524±51 kg/cm². After being stood overnight, suspension occurred in the ink, which means that the stability of the ink was poor.

### Example 3

0.5 parts by weight of B46, 1 part by weight of K64, 0.5 parts by weight of K48, 69.5 parts by weight of DMSO, 8 parts by weight of ethanol, 2 parts by weight of propanol, and 22.5 parts by weight of the ionized PPS1 were mixed to form an ink. The ink had a surface tension of 31.5 dyne/cm and a viscosity of 22.3 cp at 30° C. The ink was inkjet printed onto a powder layer of PPS, and then heated to 280° C. to form a 3D printing object having a tensile strength of 531±50 kg/cm². The ink could remain clear and transparent (stable status) for more than 4 days.

### Example 4

1 part by weight of B42, 1 part by weight of K64, 1 part by weight of K48, 72 parts by weight of DMSO, 8 parts by weight of ethanol, 2 parts by weight of propanol, and 18 parts by weight of the ionized PPS1 were mixed to form an ink. The ink had a surface tension of 26.8 dyne/cm and a viscosity of 15.7 cp at 30° C. The ink was inkjet printed onto a powder layer of PPS, and then heated to 280° C. to form a 3D printing object having a tensile strength of 524±45 kg/cm².

### Example 5

1 part by weight of B44, 1 part by weight of K48, 73 parts by weight of DMSO, 10 parts by weight of ethanol, 2 parts by weight of propanol, 1 part by weight of butanol, and 14 parts by weight of the ionized PPS1 were mixed to form an ink. The ink had a surface tension of 26.2 dyne/cm and a viscosity of 15.5 cp at 25° C. The ink was inkjet printed onto a powder layer of PPS, and then heated to 280° C. to form a 3D printing object having a tensile strength of 531±58 kg/cm².

### Example 6

1 part by weight of B44, 1 part by weight of K48, 75 parts by weight of DMSO, 11 parts by weight of ethanol, 2 parts by weight of propanol, and 12 parts by weight of the ionized PPS1 were mixed to form an ink. The ink had a surface tension of 25.6 dyne/cm and a viscosity of 14.8 cp at 25° C. The ink was inkjet printed onto a powder layer of PPS, and then heated to 280° C. to form a 3D printing object having a tensile strength of 529±54 kg/cm².

### Example 7

1 part by weight of B42, 75 parts by weight of DMSO, 11 parts by weight of ethanol, 2 parts by weight of propanol, and 12 parts by weight of the ionized PPS1 were mixed to form an ink. The ink had a surface tension of 23.9 dyne/cm and a viscosity of 14.9 cp at 25° C. The ink was inkjet printed onto a powder layer of PPS, and then heated to 280 ° C. to form a 3D printing object having a tensile strength of 525±53 kg/cm².

### Example 8

1 part by weight of B42, 1 part by weight of K64, 75 parts by weight of DMSO, 36.5 parts by weight of ethylene glycol, 12 parts by weight of ethanol, and 12 parts by weight of the ionized PPS1 were mixed to form an ink. The ink had a surface tension of 23.5 dyne/cm and a viscosity of 15.1 cp at 25° C. The ink was inkjet printed onto a powder layer of PPS, and then heated to 280° C. to form a 3D printing object having a tensile strength of 527±53 kg/cm².

### Example 9

1 part by weight of K48, 75 parts by weight of DMSO, 12 parts by weight of ethanol, and 12 parts by weight of the ionized PPS1 were mixed to form an ink. The ink had a surface tension of 23.4 dyne/cm and a viscosity of 15.3 cp at 25° C. The ink was inkjet printed onto a powder layer of PPS, and then heated to 280° C. to form a 3D printing object having a tensile strength of 523±56 kg/cm².

### Example 10

1 part by weight of B46, 1 part by weight of K64, 1 part by weight of K48, 73 parts by weight of DMSO, 12 parts by weight of ethanol, and 12 parts by weight of the ionized PPS1 were mixed to form an ink. The ink had a surface tension of 22.8 dyne/cm and a viscosity of 14.9 cp at 25° C. The ink was inkjet printed onto a powder layer of PPS, and then heated to 280° C. to form a 3D printing object having a tensile strength of 524±57 kg/cm².

### Example 11

1 part by weight of B46, 1 part by weight of K64, 1 part by weight of K48, 70 parts by weight of DMSO, 10 parts by weight of ethylene glycol, 10 parts by weight of ethanol, and 10 parts by weight of the ionized PPS1 were mixed to form an ink. The ink had a surface tension of 23.4 dyne/cm and a viscosity of 12.9 cp at 25° C. . The ink was inkjet printed onto a powder layer of PPS, and then heated to 280° C. to form a 3D printing object having a tensile strength of 527±53 kg/cm².

### Example 12

1 part by weight of B46, 1 part by weight of K64, 1 part by weight of K48, 78 parts by weight of DMSO, 8 parts by weight of ethanol, 4 parts by weight of propanol, 2 parts by weight of butanol, and 8 parts by weight of the ionized PPS1 were mixed to form an ink. The ink had a surface tension of 23.6 dyne/cm and a viscosity of 12.4 cp at 25° C. The ink was inkjet printed onto a powder layer of PPS, and then heated to 280° C. to form a 3D printing object having a tensile strength of 523±56 kg/cm².

### Example 13

1 part by weight of B46, 1 part by weight of K64, 1 part by weight of K48, 73 parts by weight of DMAc, 12 parts by weight of ethanol, and 12 parts by weight of the ionized PPS1 were mixed to form an ink. The ink had a surface tension of 23.9 dyne/cm and a viscosity of 13.2 cp at 25° C. The ink was inkjet printed onto a powder layer of PPS, and then heated to 280° C. to form a 3D printing object having a tensile strength of 524±57 kg/cm².

### Example 14

1 part by weight of B46, 1 part by weight of K64, 1 part by weight of K48, 73 parts by weight of ethylene glycol, 11 parts by weight of ethanol, 1 part by weight of propanol, and 15 parts by weight of the ionized PPS1 were mixed to form an ink. The ink had a surface tension of 24.3 dyne/cm and a viscosity of 28.5 cp at 25° C. The ink was inkjet printed onto a powder layer of PPS, and then heated to 280° C. to form a 3D printing object having a tensile strength of 526±56 kg/cm².

### Example 15

1 part by weight of B46, 1 part by weight of K64, 1 part by weight of K48, 36.5 parts by weight of NMP, 36.5 parts by weight of ethylene glycol, 11 parts by weight of ethanol, 1 part by weight of propanol, and 15 parts by weight of the ionized PPS1 were mixed to form an ink. The ink had a surface tension of 23.8 dyne/cm and a viscosity of 16.2 cp at 25° C. The ink was inkjet printed onto a powder layer of PPS, and then heated to 280° C. to form a 3D printing object having a tensile strength of 527±53 kg/cm².

### Example 16

1 part by weight of B46, 1 part by weight of K64, 1 part by weight of K48, 36.5 parts by weight of DMSO, 36.5 parts by weight of ethylene glycol, 11 parts by weight of ethanol, 1 part by weight of propanol, and 15 parts by weight of the ionized PPS1 were mixed to form an ink. The ink had a surface tension of 23.9 dyne/cm and a viscosity of 17.1 cp at 25° C. The ink was inkjet printed onto a powder layer of PPS, and then heated to 280 ° C. to form a 3D printing object having a tensile strength of 523±56 kg/cm².

### Example 17

1 part by weight of B46, 1 part by weight of K64, 1 part by weight of K48, 36.5 parts by weight of DMAc, 36.5 parts by weight of ethylene glycol, 11 parts by weight of ethanol, 1 part by weight of propanol, and 15 parts by weight of the ionized PPS1 were mixed to form an ink. The ink had a surface tension of 24.4 dyne/cm and a viscosity of 16.5 cp at 25° C. The ink was inkjet printed onto a powder layer of PPS, and then heated to 280° C. to form a 3D printing object having a tensile strength of 524±57 kg/cm².

### Example 18

1 part by weight of B46, 1 part by weight of K64, 1 part by weight of K48, 73 parts by weight of NMP, 12 parts by weight of ethanol, 2 parts by weight of propanol, 1 pat by weight of butanol, and 12 parts by weight of SPEEK were mixed to form an ink. The ink had a surface tension of 23.2 dyne/cm and a viscosity of 12.4 cp at 25° C. The ink was inkjet printed onto a powder layer of PEEK, and then heated to 280° C. to form a 3D printing object having a tensile strength of 511±49 kg/cm².

### Example 19

1 part by weight of B46, 1 part by weight of K64, 1 part by weight of K48, 73 parts by weight of NMP, 12 parts by weight of ethanol, 2 parts by weight of propanol, 1 pat by weight of butanol, and 12 parts by weight of the amino PES were mixed to form an ink. The ink had a surface tension of 23.6 dyne/cm and a viscosity of 12.9 cp at 25° C. The ink was inkjet printed onto a powder layer of PES, and then heated to 280° C. to form a 3D printing object having a tensile strength of 501±52 kg/cm².

### Example 20

1 part by weight of B46, 1 part by weight of K64, 1 part by weight of K48, 36.5 parts by weight of DMAc, 36.5 parts by weight of ethylene glycol, 11 parts by weight of ethanol, 1 part by weight of propanol, and 15 parts by weight of the ionized PPS2 were mixed to form an ink. The ink had a surface tension of 24.4 dyne/cm and a viscosity of 16.5 cp at 25° C. The ink was inkjet printed onto a powder layer of PPS, and then heated to 280° C. to form a 3D printing object.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. An inkjet ink, comprising:
a modified high-performance engineering plastic;
a polar solvent; and
a wetting agent.

2. The inkjet ink as claimed in claim 1, wherein the modified high-performance engineering plastic comprises modified polyphenylene sulfide, modified polyether-ether-ketone, modified polyether sulfone, modified polyphenylsulfone, or modified polysulfone.

3. The inkjet ink as claimed in claim 1, wherein the modified high-performance engineering plastic comprises (A) poly(alkyl-4-(thiophenyl)sulfinylbenzene); (B) polyphenylene sulfide, polyether-ether-ketone, polyether sulfone, or polyphenylsulfone grafted with carboxylate, sulfonate, phosphate, or nitrate; (C) polyphenylene sulfide, polyether-ether-ketone, polyether sulfone, or polyphenylsulfone grafted with primary amine or nitro; or (D) polysulfone inserted with polyether chain, long carbon chain, or a combination thereof.

4. The inkjet ink as claimed in claim 1, wherein the modified high-performance engineering plastic has a weight average molecular weight of 6000 to 150000.

5. The inkjet ink as claimed in claim 1, wherein the polar solvent has a Hansen solubility parameter δ of 21.5 to 33.

6. The inkjet ink as claimed in claim 1, wherein the inkjet ink has a surface tension of 20 dyne/cm to 40 dyne/cm and a viscosity of 8 cp to 30 cp at 20° C. to 60° C.

7. A 3D printing method, comprising:
(1) forming a first powder layer of a high-performance engineering plastic;
(2) applying an inkjet ink to the first powder layer to form a first pattern in the first powder layer, wherein the ink includes a modified high-performance engineering plastic, a polar solvent, and a wetting agent;
(3) pre-heating the first powder layer;
(4) forming a second powder layer of the high-performance engineering plastic on the pre-heated first powder layer;
(5) applying the inkjet ink to the second powder layer to form a second pattern in the second powder layer;
(6) pre-heating the second powder layer;
(7) removing parts of the first powder layer and the second powder layer that are not in contact with the inkjet ink; and
(8) baking remaining parts of the first powder layer and the second powder layer to form a 3D printing object.

8. The method as claimed in claim 7, wherein the high-performance engineering plastic comprises polyphenylene sulfide, polyether-ether-ketone, polyether sulfone, polyphenylsulfone, or polysulfone.

9. The method as claimed in claim 7, wherein the high-performance engineering plastic has a weight average molecular weight of 10000 to 150000.

10. The method as claimed in claim 7, wherein the modified high-performance engineering plastic comprises modified polyphenylene sulfide, modified polyether-ether-ketone, modified polyether sulfone, modified polyphenylsulfone, or modified polysulfone.

11. The method as claimed in claim 7, wherein the modified high-performance engineering plastic comprises (A) poly(alkyl-4-(thiophenyl)sulfinylbenzene); (B) polyphenylene sulfide, polyether-ether-ketone, polyether sulfone, or polyphenylsulfone grafted with carboxylate, sulfonate, phosphate, or nitrate; (C) polyphenylene sulfide, polyether-ether-ketone, polyether sulfone, or polyphenylsulfone grafted with primary amine or nitro; or (D) polysulfone inserted with polyether chain, long carbon chain, or a combination thereof.

12. The method as claimed in claim 7, wherein the modified high-performance engineering plastic has a weight average molecular weight of 6000 to 150000.

13. The method as claimed in claim 7, wherein the polar solvent has a Hansen solubility parameter δ of 21.5 to 33.

14. The method as claimed in claim 7, wherein the inkjet ink has a surface tension of 20 dyne/cm to 40 dyne/cm and a viscosity of 8 cp to 30 cp at 20° C. to 60° C.

15. The method as claimed in claim 7, wherein the steps of (3) pre-heating the first powder layer and (6) pre-heating the second powder layer are performed at a temperature of 120° C. to 180° C., and the step of (8) baking the remaining parts of the first powder layer and the second powder layer to form the 3D printing object is performed at a temperature of 250° C. to 350° C.

16. A 3D printing object, comprising:
a high-performance engineering plastic and a modified high-performance engineering plastic being homogeneously mixed,
wherein the high-performance engineering plastic comprises polyphenylene sulfide, polyether-ether-ketone, polyether sulfone, polyphenylsulfone, or polysulfone, and
the modified high-performance engineering plastic comprises modified polyphenylene sulfide, modified polyether-ether-ketone, modified polyether sulfone, modified polyphenylsulfone, or modified polysulfone.

17. The 3D printing object as claimed in claim 16, wherein the modified high-performance engineering plastic comprises (B) polyphenylene sulfide, polyether-ether-ketone, polyether sulfone, or polyphenylsulfone grafted with carboxylate, sulfonate, phosphate, or nitrate; (C) polyphenylene sulfide, polyether-ether-ketone, polyether sulfone, or polyphenylsulfone grafted with primary amine or nitro; or (D) polysulfone inserted with polyether chain, long carbon chain, or a combination thereof.

18. The 3D printing object as claimed in claim 16, wherein the high-performance engineering plastic has a weight average molecular weight of 10000 to 150000, and the modified high-performance engineering plastic has a weight average molecular weight of 6000 to 150000.
